(19) United States
(12) Patent Application Publication
(10) Pub. No.: US 2019/0311647 A1
(43) Pub. Date: Oct. 10, 2019

(54) Methods and Systems for Conversationalization of Recipes

(71) Applicant: Connected Cooking Solutions Private Limited, Bangalore (IN)

(72) Inventor: Bahubali SHETE, Bangalore (IN)

(21) Appl. No.: 16/374,886

(22) Filed: Apr. 4, 2019

Related U.S. Application Data
(60) Provisional application No. 62/652,316, filed on Apr. 4, 2018.

(51) Int. Cl. G09B 19/00; G06Q 30/02; G06N 5/02; G06N 20/00

(52) U.S. Cl. CPC G09B 19/00; G06N 20/00; G06N 5/02; G06Q 30/0255

(57) ABSTRACT

Methods and systems for providing conversational cooking assistant by adapting recipes from multiple sources, customizing the recipe for the user and deliver audio or visual assistance in executing the recipes. According to one embodiment, recipes in digital, text, audio or visual format are transformed into human-like conversations along with wait period and customized instructions for cooking the ingredients in prescribed manner.

### CLAIM OF PRIORITY

This application claims priority under 35 U.S.C. § 119 to U.S. provisional application No. 62/652,316 filed on Apr. 4, 2018 in the United States Patent and Trademark Office, the entire disclosure of which is incorporated herein by reference.

### FIELD OF THE EMBODIMENTS

The field of the embodiments relate to the field of smart voice/visual assistant for cooking.

### BACKGROUND OF THE EMBODIMENTS

Cooking is generally limited by the skills and experience of an individual. While a lot of sources provide recipes and tips for cooking, current solutions require user to manually interpret the recipe content in form of text or video and the user has to manually understand and execute the recipe. Further, the recipes are not customized according to user's preferences and taste and most sources only provide standard recipes to all users, irrespective of their preference. Customizing a recipe requires experience and effort from the user and may be difficult if the user is not very experienced in cooking. Also, the current solutions do not guide a user through the cooking process, rather they just display the recipe to the user and leave it up to the user to implement in the best way possible. For a non-experienced user, it is very difficult and time consuming to interpret the recipe through the current sources. The outcome of cooking with current solutions is not consistent even for the same recipe, considering the skillset and experience of the user has a huge impact on the results. Also, depending on the user's taste, the user may or may not like the outcome of cooking by following recipes from the traditional sources.

Thus, there is need for a solution that can guide the user in cooking in a conversational manner and can provide customized recipes in a human-like manner in audio/visual form. Further, there is need to incorporate factors such as user's skills and experience along with his/her taste preference for modifying the recipe.

### SUMMARY OF THE EMBODIMENTS

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In general, the present invention and its various embodiments convert recipe content into a format that make it a natural conversation. Once translated these can be delivered using a multi-media device or smartphone or smart assistants like Amazon Alexa or Google Home or others similar devices.

The present invention provides a method and system to convert recipes into a conversational format, add waiting time in accordance with time required for performing the respective steps, customize the recipe in accordance with user's preferences and skills and provide the recipe the user in form of a conversation.

The present invention provides a method of providing cooking assistance, the method comprising the steps of: receiving a set of cooking instructions from one or more sources in form of text, video or audio; interpreting the set of instructions using artificial intelligence; receiving user data in form of preferences, choices and skills; receiving a request for a set of cooking instructions from the user in voice format; customizing the instructions based on user preferences, choices and skills; converting the instructions in voice format; determining one or more waiting duration based on cooking time required for the respective cooking steps in accordance with the instructions; determining relevant products for advertising to the user; presenting the instructions in a form of a conversation wherein each instruction is spoken or displayed to the user and a timer is started for the respective waiting time at respective step; asking questions to the user during the waiting time to receive user preferences, choices and skills; advertising relevant products to the user during the waiting time. The method further comprises a set of instructions received in text format, audio forma and video format. The method further comprises augmenting the set of modified set of instructions in response to an audio interruption from the user. The method further comprises wherein the audio interruption is either one of a taste preference, is an ingredient request, a seasonal request, a request for more details. The method further comprises wherein the augmenting includes repeating a previous portion of the set of instruction at a higher level of detail. The method further comprises wherein augmenting includes proceeding to a following portion the set of instructions at lower level of detail. The method further comprises wherein the ingredients in the set of instructions are modified based on user preference. The method further comprises wherein cooking tips are added to the set of cooking instructions. The method further comprises storing the modified set of instructions for repeated use.

The present invention also teaches a system for providing cooking assistance, the system comprising: at least one processor coupled to a memory, the processor executes an algorithm for:
receiving device for receiving a set of cooking instructions from one or more sources in form of text, video or audio; interpreting the set of instructions using artificial intelligence; receiving user data in form of preferences, choices and skills; customizing the instructions based on user preferences, choices, allergens and skills; converting the instructions in voice or video format; determining one or more waiting duration based on cooking time required for the respective cooking steps in accordance with the instructions; determining relevant products for advertising to the user;
at least one communication device performing the steps of: receiving a request for a set of cooking instructions from the user in voice format; presenting the instructions in a form of a conversation wherein each instruction is spoken or displayed to the user and a timer is started for the respective waiting time at respective step; asking questions to the user during the waiting time to receive user preferences, choices and skills; advertising relevant products to the user during the waiting time.

In addition to the foregoing, other objects, features, aspects and advantages of the present invention will be better comprehended through a careful reading of a detailed description provided herein below with appropriate reference to the accompanying drawings.

### BRIEF DESCRIPTION OF THE DRAWINGS

FIG. 1 illustrates a flow diagram disclosing key steps of the invention.

FIG. 2 shows a block diagram disclosing key components of the invention.

FIG. 3 illustrates a flow diagram for conversationalization of recipes in accordance with the invention.

### DETAILED DESCRIPTION OF THE PREFERRED EMBODIMENT

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CDROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Embodiments of the present invention provide systems and methods for converting the recipe content from any digital format into natural conversations that aid the cooks and or train cooks and or coach cooks during cooking. Certain embodiments provide additional guidance to avoid or correct mistakes in the cooking process and allow for the customization of recipes to address, e.g., dietary restrictions, culinary preferences, translation into a foreign language, etc.

Described herein are the methods, computer systems and software for providing a conversational cooking assistant. The following detailed description of the invention refers to the accompanying drawings.

The present invention and its various embodiments take recipe content from multiple sources, in multiple formats and convert the recipe content into a human-like conversation format. Once converted, the recipe content can be delivered using a multi-media device or smartphone or smart assistants like Amazon Alexa or Google Home or others similar devices.

The translation of the recipe content into a format that make it a natural conversation is termed by this invention as “Conversationalization” and the output artefact is termed in this invention as “Conversational Recipe”.

Once converted these recipes can be delivered using a multi-media device or smartphone or smart assistants such as Google Home, Amazon Alexa etc.

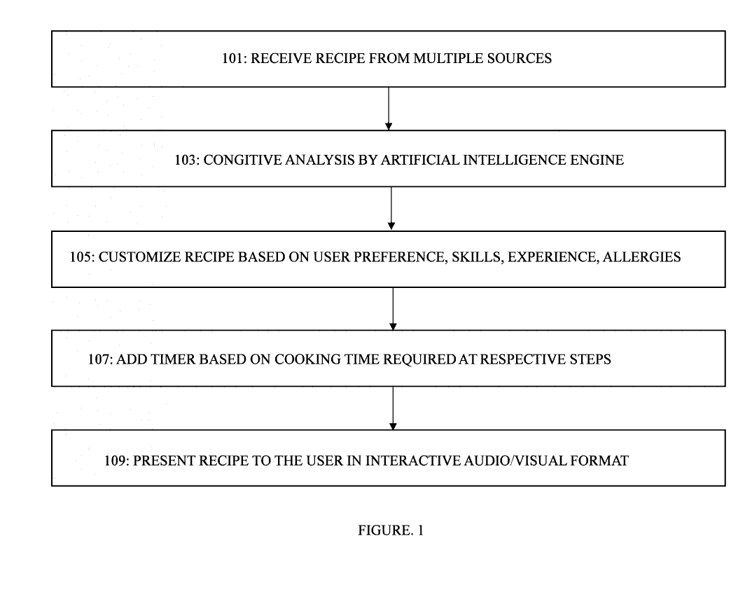

FIG. 1 discloses a flow diagram to explain the multiple steps executed by the present invention. At step 101, recipe content is received from multiple sources. These sources could comprise one or more of databases, websites, APIs, providing recipes in the form of text, audio or video. At step 103, an artificial intelligence engine performs cognitive analysis on the received recipes. This cognitive analysis converts the recipes into a conversational format i.e. performs conversationalization of the recipe. Further, it determines appropriate products to be presented to the user in form of advertisements during cooking. At step 105, the recipe is customized according to factors such as user's preferences, preferred cuisine, skills, experience and allergies. At step 107, at least one timer or pause is determined according to waiting time in the respective steps in the recipe. At step 109, the recipe is presented to the user in conversational manner in form of audio or video.

In accordance with the present invention, the recipe is presented to the user in a conversational manner, i.e. the invention acts as a cooking assistant that engages the user in a human-like conversation throughout the cooking process. Further, in accordance with one of the embodiments, the invention provides advertisements to the users for products relevant to the recipe or based on user's history, preferences and choices.

In accordance with another embodiment, the invention receives user's preferences, choices and skills by interacting with the user during the wait time for the respective cooking steps. This is achieved by asking multiple questions to the users in form of a conversation to analyze the user's preferences and choices. Also, the invention uses machine learning to further define user's preferences, skills, allergies etc. This feature is significant because it saves the trouble of filling user input forms to identify user's preferences, choices and skills and performs efficient utilization of waiting time during cooking.

Further, the invention also provides relevant advertisements to further utilize the wait time during cooking. The relevant advertisements could be determined based on user's preferences, skills, history or based on the current recipe being provided to the user.

The invention also learns from user's feedback and user history to further refine the recipes being presented to the user.

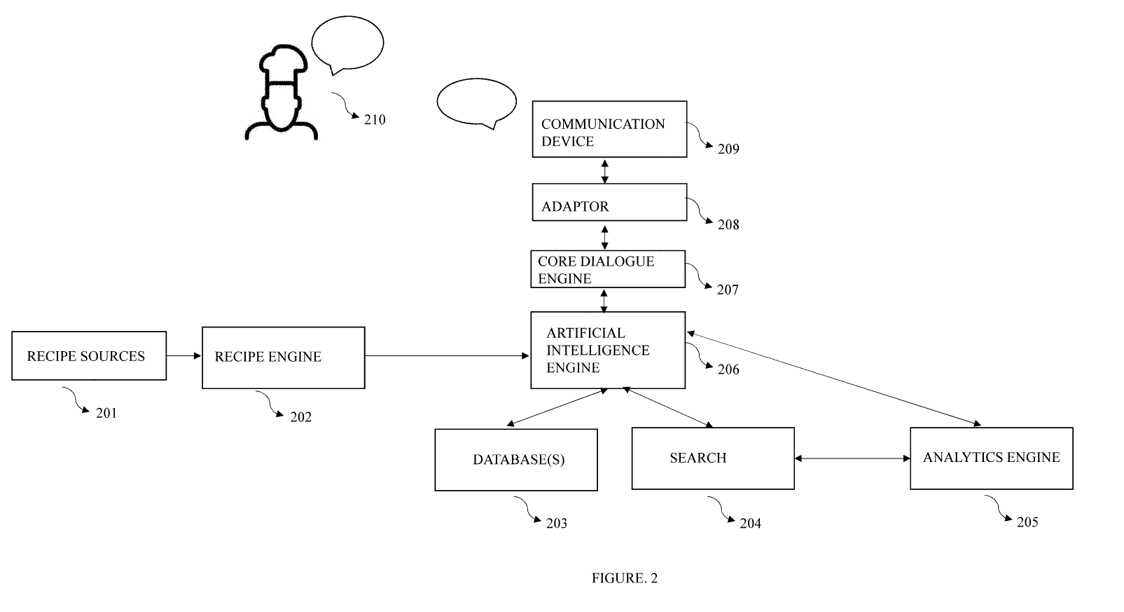

FIG. 2 discloses a block diagram to illustrate the components of the invention. 201 represents recipe sources such as websites, APIs, databases etc. These recipes could be received in form of text, audio or video and are processed by the recipe engine 202. The processed recipes are then provided to the artificial intelligence engine 206, which further receives data from database 203 and search component 204. The database stores the processed recipe information along with information related to user profiles, preferences, history, feedback, allergies and skill set, along with information regarding advertisements, cooking tips to be presented to the user and/or recipes processed by the recipe engine 202. This data is also provided to an analytics engine 205 that performs further processing on the data and provides the results to the artificial intelligence engine 206. The artificial intelligence engine 206 then performs cognitive analysis to refine the recipes and customize them. These refined and customized recipes are then provided to the core dialogue engine 207 which delivers the recipes in conversational format. The recipe content may be processed using speech recognition technologies and artificial intelligence technologies known to the art, such as neural networks, hidden Markov models, or other AI platforms such as but not limited to tensor flow, spark and other similar platforms. The artificial intelligence engine 206 also determines advertisements to be presented to the user based on factors such as context of the current recipe, user's history and preferences. Further, it customizes the recipe in accordance with user's preferences, skills, allergies, feedback and choices and determines waiting time at respective set of instructions within the recipe. The recipe in conversational format is then sent from the core dialogue engine 207 to a communication device 209 via adaptor 208. The adaptor 208 acts an interface between the communication device 209 and the core dialogue engine 207. The user 210 asks for the recipe in form of a voice or text command and the communication device 209 presents the recipe to the user 210 in form of a conversation in audio and/or video format. Further, the communication device 209 implements one or more timers for the waiting time determined for the respective set of instructions, depending on the set of instructions determined by the artificial intelligence engine 206. During the waiting time, the communication device 209 asks multiple questions to the user 210 to determine user's preferences, preferred cuisine, skills and choices and sends the same to the artificial intelligence engine 206, which then gets stored in database 203 and is used to customize the recipes for the user in future. Further, it presents relevant advertisements to the user during the waiting time to further utilize the waiting time efficiently.

The communication device 209 could be a smart home assistant such as Amazon Alexa, Google Home or a similar device or a smart phone device.

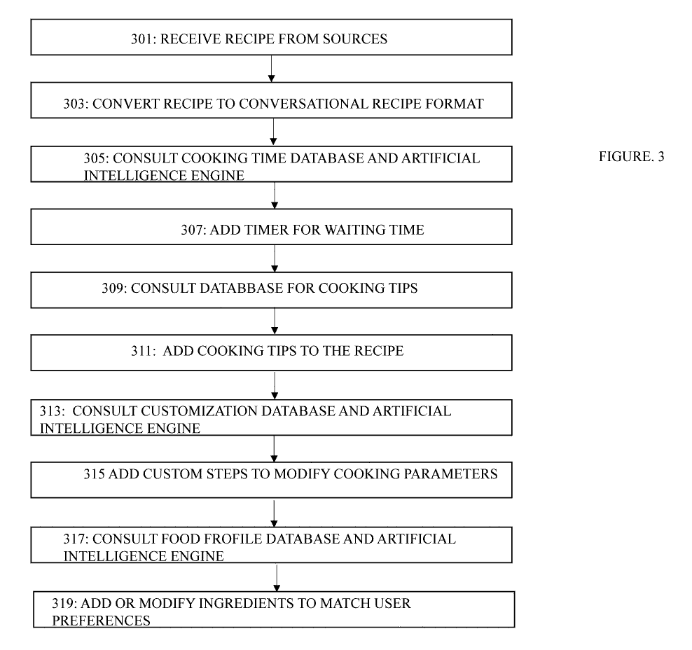

FIG. 3 discloses another embodiment of the present invention. At step 301, recipes are received from multiple sources in form of text, audio, video etc. At step 303 the received recipes are converted into a conversational format. At step 305, a cooking time database and an artificial intelligence engine are consulted to modify the recipe to add a waiting time for the respective steps of the recipe, at step 307. Further, a cooking tips database is consulted at step 309 and cooking tips are added to the recipe at step 311. At step 313, another database and artificial intelligence engine are consulted to customize the recipe in accordance with user's preferences, choices and skills at step 315. The database could store data related to user's profiles, preferences, skills and choices. At step 317, a food profile database and artificial intelligence engine are consulted to further modify ingredients based on user preferences, at step 319.

Thus, the invention may use multiple databases and artificial intelligence engines to present recipe in form a conversation to the user in an efficient manner.

The recipe content may be processed using speech recognition technologies and artificial intelligence technologies known to the art, such as neural networks, hidden Markov models, or other AI platforms such as but not limited to tensor flow, spark and other similar platforms.

Below is an example of omelet's recipe being presented to the user in conversational manner in accordance with the invention:

“Let's get started, I have sent the ingredients to you, please check and confirm you have all the ingredients ready to cook.”

<<pause for user to confirm>>

“Also you need from your pantry a small mixing bowl <<Long Pause>> 6 to 8 inch Omelet pan <<Long Pause>> and a spatula.”

<<Long Pause>>“Are you ready for the first step?”

<<pause for user to confirm>>

“Beat eggs in a small bowl. Chef's Tip, beat until it is blended”

<<Pause for a minute>>

“Heat butter in 6 to 8-inch non-stick omelet pan or skillet over medium-high heat until hot.”

<<Pause for a minute>>

“Pour in egg mixture.”

<<short pause>>

“Continue cooking, <<short pause>> tilting pan and gently moving cooked portions as needed.”

<<Pause for two minutes>>

“When top surface of eggs is cooked, <<short pause>> place filling on one side of the omelet.”

<<Pause for two minutes>>

“Fold omelet in half with turner.”

<<Long Pause>>

“With a quick flip of the wrist, <<Long Pause>>, turn pan and invert or slide the omelet onto plate.”

<<Pause for a minute>>

“The omelet is ready to serve, bon appetite”.

The invention provides recipes to the user in a very user friendly manner and acts as a cooking assistant by understanding the user's preferences, skills and choices. The recipes are presented in form of a conversation and are tailored in accordance with user's preferences, choices, skills, allergens and historic data. Further, the invention also adds a waiting time during the cooking so as to enable user to cook in efficient and guided manner. The waiting time is efficiently utilized to receive user input related to preferences, choices and skills and are used to further improvise the recipes in future. The waiting time is also used to present relevant advertisements to the user to further make use of the time efficiently or to engage in conversation with the user.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method of providing cooking assistance, the method comprising the steps of:
receiving a set of cooking instructions from one or more sources in form of text, video or audio;
interpreting the set of instructions using artificial intelligence;
receiving user data in form of preferences, choices and skills;
receiving a request for a set of cooking instructions from the user in voice or text format;
customizing the instructions based on user preferences, choices, skills, allergens and user's historic data;
converting the instructions in voice or video format;
determining one or more waiting duration based on cooking time required for the respective cooking steps in accordance with the instructions;
determining relevant products for advertising to the user;
presenting the instructions in a form of a conversation wherein each instruction is spoken or displayed to the user and a timer is started for the respective waiting time at respective step;
asking questions to the user during the waiting time to receive user preferences, choices and skills;
advertising relevant products to the user during the waiting time.

2. The method of claim 1, wherein the set of instructions is received in text format.

3. The method of claim 1, wherein the set of instructions is received in an audio format.

4. The method of claim 1, wherein the set of instructions is received in video format.

5. The method of claim 1, further comprising augmenting the set of modified instructions in response to an audio interruption from the user.

6. The method of claim 5, wherein the audio interruption is either one of a taste preference, is an ingredient request, a seasonal request, a request for more details.

7. The method of claim 5, wherein augmenting includes repeating a previous portion of the set of instruction at a higher level of detail.

8. The method of claim 5, wherein augmenting includes proceeding to a following portion the set of instructions at lower level of detail.

9. The method of claim 1 wherein the ingredients in the set of instructions are modified based on user preference.

10. The method of claim 1, wherein the user is provided with a brief summary of the set of instructions.

11. The method of claim 1, wherein cooking tips are added to the set of cooking instructions.

12. The method of claim 1, further comprising storing the modified set of instructions for repeated use.

13. The method of claim 1, wherein the set of instructions are customized to identify allergens and user is notified of the allergens.

14. The method of claim 1, wherein the user data comprises cuisine as an input.

15. The method of claim 1 further including engaging in conversation with the user during the waiting time.

16. The method of claim 1 further including receiving feedback from user during the waiting time.

17. A system for providing cooking assistance, the system comprising:
at least one processor coupled to a memory, the processor executes an algorithm for:
receiving device for receiving a set of cooking instructions from one or more sources in form of text, video or audio;
interpreting the set of instructions using artificial intelligence;
receiving user data in form of preferences, choices and skills;
customizing the instructions based on user preferences, choices, skills, allergens and user's historic data;
converting the instructions in voice or video format;
determining one or more waiting duration based on cooking time required for the respective cooking steps in accordance with the instructions;
determining relevant products for advertising to the user;
at least one communication device performing the steps of:
receiving a request for a set of cooking instructions from the user in voice or text format;
presenting the instructions in a form of a conversation wherein each instruction is spoken or displayed to the user and a timer is started for the respective waiting time at respective step;
asking questions to the user during the waiting time to receive user preferences, choices and skills;
advertising relevant products to the user during the waiting time.
